(19) United States
(12) Patent Application Publication
(10) Pub. No.: US 2008/0080184 A1
(43) Pub. Date: Apr. 3, 2008

(54) Pixilated LED Light Source for Channel Letter Illumination

(75) Inventor: Densen Cao, Sandy, UT (US)

Correspondence Address: GEOFFREY E. DOBBIN, PATENT ATTORNEY, 4278 SOUTH 6220 WEST, WEST VALLEY CITY, UT, 84128-6501, US

(73) Assignee: CAO Group Inc., West Jordan, UT (US)

(21) Appl. No.: 11/538,357

(22) Filed: Oct. 3, 2006

(51) Int. Cl. F21S 13/14

(52) U.S. Cl. 362/252

(57) ABSTRACT

The present invention is an LED module for channel letter illumination utilizing multiple through-hole LEDs in a pixel formation as a light source where one surface mounted LED or other forms of LEDs were previously used. The use of a number of small through-hole LEDs ideally requires that a beam angle between and including 15° and 180° in vertical and horizontal directions, respectively, be utilized. When multiple light sources are used on a module, the distance between light sources is to be between 20 mm and 1 cm. The use of several smaller LEDs reduces the current needed to generate light of appropriate intensity and, thus reduces energy cost and heat generation. The use of smaller LEDs also assists in excess heat dissipation.

### FIELD OF THE INVENTION

The present invention relates to the field of channel letter illumination and more particularly relates to an efficient use of a customized through-hole LEDs to provide channel letter illumination.

### BACKGROUND OF THE INVENTION

In recent years, LEDs have been used in commercial signage applications, particularly in channel letters in place of neon and other fluorescent lighting. One common construction of LED signage involves mounting at least one LED on a small module that can be attached in a string of such modules into channel letter forms. The string of modules is formed by each module and wires connecting them together, forming a relatively flexible lighted strand of LEDs for use in these applications. Each module must be constructed to withstand and disperse the heat generated by a single LED at it is powered to achieve useful intensity. Channel letter construction typically does not allow for efficient dispersion of heat as the letter forms are typically closed with tight interiors. Therefore, heat dispersion tends to be addressed in the construction of the LED modules by adding or making the modules themselves heat sinks. Heat sinks, however, collect heat and are typically a slow way to dissipate heat. Unfortunately, excess heat tends to lessen LED life and affect intensity, so added heat has a deleterious effect on LED signage.

The present invention is the use of a plurality of smaller, more efficient LEDs, in place of one LED on a module. The smaller LEDs are positioned in a formation called a pixel and the plurality of LEDs together generate the same light intensity with lower energy consumption and heat generation than a single large LED alone. The present invention represents a departure from the prior art in that the pixel formation of the present invention allows for use of smaller LEDs, with their efficiency benefits for lower energy costs, and lower construction cost as heat generation is less of a factor.

### SUMMARY OF THE INVENTION

In view of the foregoing disadvantages inherent in the known types of LED lighting modules, this invention provides an improved LED lighting module that reduces both energy consumption and heat generation by using LEDs previously though too small for channel letter signage purposes.

To accomplish these objectives, the modules comprise an outer casing, ideally made of plastic, with an internal printed circuit board and driving circuit. Small, through-hole LEDs protrude through an upper surface of the module in a formation called a pixel, where the entire pixel is designed to replace a single LED as used in prior art applications. As such, the LEDs have a larger beam angle than prior art LEDs (which tend to be more focused) and the pixel shape in and of itself is chosen to maximize coverage. The modules according to the present invention generate significantly less heat than prior art modules, so a heat sink is unnecessary, leaving out a significant cost and weight to the modules.

The more important features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. It is also to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view of a prior art LED module for channel letter illumination.

FIG. 2 is a perspective view of an LED module according to the present invention.

FIG. 3 is a cross-sectional view, taken lengthwise just right of the centerline, of the module of FIG. 2.

### DETAILED DESCRIPTION OF THE PREFERRED EMBODIMENT

With reference now to the drawings, the preferred embodiment of the pixilated LED lighting module is herein described. It should be noted that the articles “a”, “an” and “the”, as used in this specification, include plural referents unless the content clearly dictates otherwise.

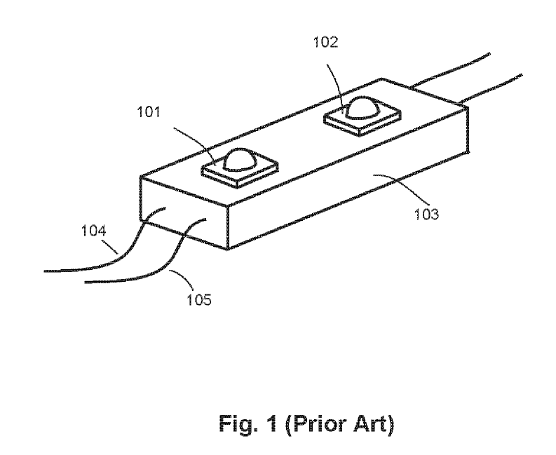

FIG. 1 depicts prior art, using piranha LEDs as light source for channel letter illumination. This format, using such large surface mounted LEDs 101, 102 as a light source, is widely used in the market. LEDs 101 and 102 in this example are piranha LEDs mounted on the upper surface of module 103. Most of the module 103 is metal to dissipate the heat generated by piranha LEDs 101 and 102. A plurality of modules 103 are electrically connected by wires 104, 105 and mounted in a channel letter for signage illumination. The disadvantage of this light source is that the both the intensity of emitted light and the covering angle are limited. Another issue is that a high input current has to be used with piranha LEDs in order to achieve high intensity, in turn generating more heat. Excess heat is detrimental for both LED intensity and lifetime so a metal base must be used to dissipate that heat. Since channel letter illumination uses a closed environment, heat dissipation is critical.

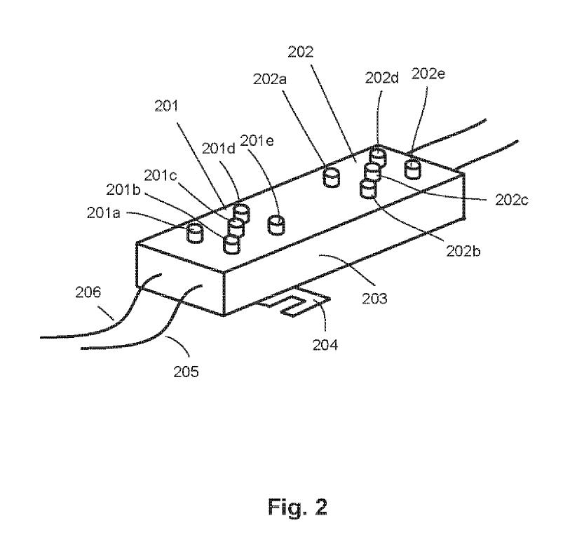

FIG. 2 depicts a module according to the present invention using LED pixels as light source for channel letter illumination. Ideally, the distance between pixels ranges from 20 mm to 1 cm. Pixel light sources 201 and 202 consist of a group of through-hole LEDs. The number of LEDs can be 3, 4, 5, more and etc. The figure illustrates two groups of 5 LEDs (201a-201e and 202a-202e) as pixel light sources where each LED is a through-hole LED. The LEDs can be 3 mm, or 5 mm oval or round through-hole type LEDs. Since both round and ovular shapes are elliptical, the term “elliptical” or “elliptically shaped” will be used in this application and the appended claims to include both round and ovular shapes. The LEDs may, of course, be of any color and combinations of colors in the pixel formation can yield colors that are not currently available in pure LED form. The most important parameters for the LEDs are LED beam angle and intensity. The intensity is dependent of applications. The preferred beam angle is larger than 15 degrees in each direction (horizontal and vertical) for either round or oval beams. The wide angle provides a more uniform light distribution than conventional surface mounted LEDs would. The preferred beam angle has an upper limit of 180 degrees. The arrangement of LEDs can be in any certain pattern, such as arcs, ellipses (including circles), stars, asterisks, triangles, squares, or rectangular patterns, to meet the light output requirements.

Plastic casing 203 encloses the light source 201, 202 and may or may not, depending on the desire of the user, be able to be reopened for maintenance. There is an attachment means, such as socket 204, on the casing 203. In the case of socket 204, a screw may be used to secure the module into the wall of channel letter. The socket 204 can be placed in any position on casing 203 for securing the casing to the wall of channel letter. There are connection wires 205 and 206 extending out of casing 203 for interconnection of pixel light modules. The module is sealed with glue or epoxy, particularly around the LEDs, for water or moisture proofing.

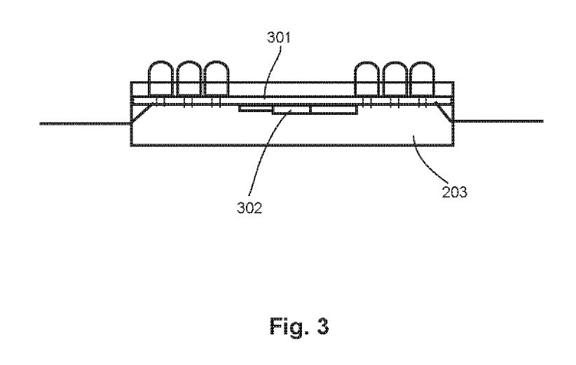

FIG. 3 depicts the cross section for a module with LED pixels as light source. Inside casing 203, there is a printed circuit board (PCB) 301 onto which through-hole LEDs are soldered. On the PCB board, there is an electronic circuit 302 to control the electrical current to each pixel. Preferably, the current to each LED is in constant current format. Since the through-hole LEDs require less current to drive and do not generate a large amount of heat, no heat sink in the form of metal casings and fillers are required. The circuit board can also be coated with epoxy or other conforming coating for water proofing purposes.

Although the present invention has been described with reference to preferred embodiments, numerous modifications and variations can be made and still the result will come within the scope of the invention. No limitation with respect to the specific embodiments disclosed herein is intended or should be inferred.

1. A light source module for channel letter illumination comprising:
a. a casing having electrical and physical connection means;
b. a populated printed circuit board, contained within the casing and operably connected
to the electrical connection means;
c. at least one pixel light source further comprised of a plurality of through-hole LEDs, each being a sub-pixel, in operable connection to the printed circuit board and arranged in a pixel formation with at least one other LED, said through-hole LEDs protruding through an upper surface of the casing;
wherein, the pixel formation is a shape chosen in such a manner to foster uniform light output.

2. The light source of claim 1, the module having a driving circuit operably connected to the LEDs and the printed circuit board to regulate the current and voltage to LEDs.

3. The light source of claim 2, the through-hole LEDs being elliptically shaped.

4. The light source module of claim 3, the LEDs have an emitting beam angle in a range between and including 15 and 180 degrees in both horizontal and vertical directions, respectively.

5. The light source of claim 4, the pixel formation being a pattern duplicating a shape chosen from the set of shapes consisting of: stars, asterisks, triangles, squares, rectangles, ellipses, arcs, and any combination of the previously mentioned shapes.

6. The light source of claim 5, the through-hole LEDs having at least one color being selected from the set of colors consisting of red, green, blue, yellow, purple, and white.

7. The light source of claim 6, having a plurality of light sources and a distance between light sources being in a range from 20 mm to 1 cm, inclusive.

8. The light source of claim 7, the entire module being waterproof.

9. The light source of claim 7, the light source being waterproof due to sealing by use of at least one sealant to cover the both the circuit board and light source, said at least one sealant being selected from the set of sealants consisting of: epoxy, glue, and paint.

10. The module of claim 7, the casing being capable of being opened for maintenance purposes.

11. The light source module of claim 1, the through-hole LEDs being elliptically shaped.

12. The light source module of claim 1, the LEDs have an emitting beam angle in a range between and including 15 and 180 degrees in both horizontal and vertical directions, respectively.

13. The light source of claim 1, the pixel formation being a pattern duplicating a shape chosen from the set of shapes consisting of: stars, asterisks, triangles, squares, rectangles, ellipses, arcs, and any combination of the previously mentioned shapes.

14. The light source of claim 1, the through-hole LEDs having at least one color being selected from the set of colors consisting of red, green, blue, yellow, purple, and white.

15. The light source of claim 1, having a plurality of light sources and a distance between light sources being in a range from 20 mm to 1 cm, inclusive.

16. The light source of claim 1, the entire module being waterproof.

17. The light source of claim 1, the light source being waterproof due to sealing by the use of at least one sealant being selected from the set of sealants consisting of: epoxy, glue, and paint; wherein the sealant is used to cover the both the circuit board and light source.

18. The light source of claim 1, the casing being capable of being opened for maintenance purposes.

19. A light source module for channel letter illumination comprising:
a. a casing having electrical and physical connection means;
b. a populated printed circuit board, contained within the casing and operably connected to the electrical connection means;
c. at least one pixel light source further comprised of a plurality of through-hole LEDs, each being a sub-pixel, in operable connection to the printed circuit board and arranged in a pixel formation with at least one other LED, said through-hole LEDs protruding through an upper surface of the casing;
d. the plurality through-hole LEDs having at least two represented colors being selected from the set of colors consisting of red, green, blue, yellow, purple, and white.
wherein, the pixel formation is a shape chosen in such a manner to foster uniform light output and the choice of represented colors generates a color not capable of being generated by a single LED.
